(19) United States
(12) Patent Application Publication
(10) Pub. No.: US 2025/0318565 A1
(43) Pub. Date: Oct. 16, 2025

(54) METHODS OF PROCESSING PEANUT BUTTER COVERED FROZEN FOOD PRODUCTS

(71) Applicant: Tru Fru, LLC, Salt Lake City, UT (US)

(72) Inventor: Taz Murray, Salt Lake City, UT (US)

(21) Appl. No.: 19/048,778

(22) Filed: Feb. 7, 2025

Related U.S. Application Data
(63) Continuation of application No. 17/340,711, filed on Jun. 7, 2021, now abandoned.

(51) Int. Cl. A23P 20/18; A23B 7/04; A23G 1/30; A23G 1/54; A23L 19/00; A23L 25/10; A23P 20/10; B65G 49/00

(52) U.S. Cl. CPC A23P 20/18; A23B 7/0416; A23G 1/305; A23G 1/54; A23L 19/05; A23L 25/10; A23P 20/11; B65G 49/00; A23V 2002/00; B65G 2201/0211

(57) ABSTRACT

A method of applying thin layers of a peanut butter and a molten chocolate onto a frozen food product, in some instances fruit, that is at temperatures below 0° C. in such a way that reduces free oil migration out of the peanut butter and prevents discoloration and brittleness of the applied chocolate.

### BACKGROUND OF THE INVENTION

### 1. Field of the Invention

The present disclosure generally relates to methods of processing peanut butter covered, and chocolate covered frozen food products.

### 2. Background and Related Art

Many people enjoy peanut butter and chocolate covered confections.

### BRIEF SUMMARY OF THE INVENTION

The present invention relates to improved methods for completely enrobing a frozen food product in thin layers of peanut butter and chocolate. The invention also relates to a unique peanut butter coating composition and processing the peanut butter coating in a frozen state, thereby reducing free oil migration. The invention also relates to the ability to envelop the frozen food product in a second thin layer of untempered, pure cocoa butter chocolate to prevent the chocolate from becoming cloudy or frangible, and then rapidly chill and freeze the enrobed frozen food product.

In some embodiments, a frozen food product includes a frozen fruit. In some embodiments, the frozen fruit includes a slice of banana, a raspberry, a blueberry, a strawberry, a cherry, or any other suitable bite-size fruit or piece of fruit.

In some embodiments, a peanut butter coating comprises peanuts ground into a fine paste, salt, and pure, high cocoa content white chocolate. Importantly, this unique composition contains no preservatives and no stabilizers. Adding pure, high cocoa content white chocolate to the peanut butter coating aids in binding peanut oil in the finely ground peanut paste, thereby reducing free oil migration. This reduction in free oil migration produces desirable flow characteristics in the peanut butter coating, reduces typical hygroscopic properties of the peanut butter, and facilitates bonding between a first thin layer of peanut butter coating and a second thin layer of chocolate.

In some embodiments, the peanut butter coating is processed in a frozen state by enrobing a frozen food product and immediately freezing the enrobed frozen food product. Processing the peanut butter coating in a frozen state contributes to further slowing the free oil migration out of the peanut butter coating to prevent blooming in a second thin layer of chocolate and increase the shelf life of the enrobed frozen food product. Additionally, processing the peanut butter coating in a frozen state further aids in reducing hygroscopic properties and facilitates bonding between a first thin layer of peanut butter coating and the second thin chocolate layer.

In some embodiments, an enrobing chocolate comprises a pure cocoa butter chocolate with additional cocoa butter, resulting in a pure, high cocoa content chocolate. Increasing the amount of cocoa butter in chocolate decreases the chocolate's melting point to achieve a low viscosity chocolate with good flow characteristics. In some embodiments, the chocolate is untempered and processed at a temperature between about 37.8° C. and about 43.3° C. Using untempered chocolate allows rapid cooling and freezing of the enrobed frozen food product as soon as the chocolate is applied, thereby preventing discoloration and brittleness of the chocolate coating.

In some embodiments, a frozen food product is received for processing, including whole pieces and partial pieces. Accordingly, in some embodiments, a first step in the process includes sorting the frozen food product to remove any pieces of the frozen food product that are too small to process. In some embodiments, the frozen food product then travels along a conveyor belt through a first enrober, where it is completely enveloped in a first thin layer of peanut butter coating, creating an enrobed frozen food product. In some embodiments, the enrobed frozen food product is then conveyed along a shaking belt and through high-velocity blowers to remove all peanut butter coating in excess of a thin layer. In some embodiments, the enrobed frozen food product is then conveyed along a cooling belt to harden a bottom surface of the peanut butter coating that is in contact with the cooling belt. In some embodiments, the enrobed frozen food product is then conveyed through a second enrober, where it is coated in a second thin layer of chocolate. In some embodiments, the second layer of chocolate includes a white chocolate, a dark chocolate, or a milk chocolate. Because the chocolate is untempered, the enrobed frozen food product is immediately cooled and frozen, and then packaged in a refrigerated environment to prevent condensation from forming on the enrobed frozen food product.

Reference throughout this specification to features, advantages, or similar language does not imply that all the features and advantages that may be realized with the present disclosure should be or are in any single embodiment of the invention. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment, but may refer to every embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The features and advantages of the present disclosure will become more fully apparent from the following description and appended claims or may be learned by the practice of the Invention as set forth hereinafter.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail using the accompanying drawings in which:

FIG. 1 shows an elevation view of a frozen banana or other frozen food product;

FIG. 2 shows a flow diagram comprising an overview of the steps of the present invention;

FIG. 3 shows a flow diagram of a sorting step;

FIG. 4 shows a flow diagram of a first enrobing step;

FIG. 5 shows an elevation view of a blowing and shaking step;

FIG. 6 shows a flow diagram of a second enrobing step; and

FIG. 7 shows a cross-sectional view of an enrobed frozen banana or other frozen food product.

### DETAILED DESCRIPTION OF THE INVENTION

The term “food product” refers to all substances that are usually composed of carbohydrates, fats, proteins, or water and can be eaten or drunk by any animal, including humans, for nutrition or pleasure, energy, or building tissue.

The term “hygroscopic” refers to the nature of a substance tending to absorb moisture from another substance.

The term “free oil migration” refers to the diffusion of oil from a high oil content confection into an adjacent lower oil content confection to achieve equilibrium.

The term “bloom” refers to changes in the fat crystals of a chocolate, causing damage to the appearance of the chocolate and lessening its shelf life.

The terms “brittleness” and “frangible” refer to a chocolate coating that is easily broken, cracked, or snapped.

The terms “discoloration” and “clouding” refer to a chocolate coating that exhibits a hazy surface appearance.

The present invention relates to improved methods for completely enrobing a frozen food product in thin layers of peanut butter and chocolate. The invention also relates to a unique peanut butter coating composition and processing the peanut butter coating in a frozen state, thereby reducing free oil migration. The invention also relates to the ability to envelop the frozen food product in a second thin layer of untempered, pure cocoa butter chocolate to prevent the chocolate from becoming cloudy or frangible, and then rapidly chill and freeze the enrobed frozen food product.

Many people enjoy peanut butter and chocolate covered confections. Conventional methods for coating confections with a peanut butter include enrobing a confection with a peanut butter coating containing preservatives and stabilizers. Adding stabilizers to the peanut butter reduces the amount of free peanut oil that migrates out of, or separates from, the peanut butter. This phenomenon is referred to as “free oil migration.” Without stabilizers to reduce the free oil migration, the peanut butter coating develops poor flow characteristics. For example, the peanut butter coating develops “torn sheets” instead of flowing in a consistent, uniform curtain as the peanut butter coating is pumped through in an enrober. These torn sheets of the peanut butter coating make it challenging to achieve a completely and evenly coated confection. Additionally, free oil migration results in undesirable blooming in an adjacent chocolate layer. Blooming causes the chocolate to develop an undesirable appearance and reduces the confection's shelf life. Additionally, free oil migration results in unwanted hygroscopic properties in the peanut butter coating. Without oil suspended in the peanut butter coating, it draws water out of any adjacent hydrated confection, causing the confection to dry out and develop an undesirable mouthfeel. Finally, free oil migration can make it challenging to bond or adhere to any additional coatings to the outside of the peanut butter coating.

Conventional methods for coating chocolate covered confections include enrobing a confection with a tempered, high viscosity robing chocolate. The conventional robing chocolate commonly includes supplemental agents, such as coconut oil or butter, to decrease the melting point of the chocolate, thereby creating a “compound coating.” Chocolate with a low melting point enables a sensation referred to as “meltaway” wherein the chocolate begins to melt immediately when placed in a consumer's mouth. Additionally, compound coatings create a softer chocolate that is more pleasing to bite into when frozen. When enrobing a frozen food product with typical compound coatings, the high viscosity robing chocolate tends to adhere to the frozen food product creating an undesirable, thick layer of chocolate rapidly. Lastly, one skilled in the art will appreciate that by conventional methods, processing chocolate typically requires tempering the chocolate to achieve an evenly colored coating.

Using the present invention, it is possible to enrobe a frozen food product with a first thin layer of peanut butter coating and a second thin layer of untempered, low viscosity, pure cocoa butter chocolate. A unique peanut butter coating comprises peanuts ground into a fine paste, salt, and pure, high cocoa content white chocolate. The addition of pure, high cocoa content white chocolate aids in binding the free peanut oil in the finely ground peanut paste, thereby reducing free oil migration. Importantly, this unique composition contains no preservatives and no stabilizers. Reducing free oil migration out of the peanut butter coating results in desirable flow characteristics, reduces typical hygroscopic properties, and facilitates bonding between a first thin layer of peanut butter coating and a second thin layer of chocolate.

Additionally, processing the peanut butter coating in a frozen state contributes to further slowing the free oil migration out of the peanut butter coating to prevent blooming in a second thin layer of chocolate and increase the shelf life of the enrobed frozen food product. Processing the peanut butter coating in a frozen state also aids in further reducing hygroscopic properties and facilitates bonding between a first thin layer of peanut butter coating and the second thin chocolate layer.

The special blend of pure cocoa butter chocolate decreases the chocolate's melting point to achieve the meltaway sensation without any supplemental agents. The thin layers allow a consumer to bite into the frozen product effortlessly. Finally, processing untempered chocolate allows the enrobed frozen food product to be rapidly cooled and flash-frozen immediately after enrobing, thereby eliminating the need to slowly cool a tempered chocolate.

A description of embodiments of the present invention will now be given with reference to the Figures. It is expected that the present invention may take many other forms and shapes. Hence the following disclosure is intended to be illustrative and not limiting, and the scope of the invention should be determined by reference to the appended claims.

Referring now to FIGS. 1-7.

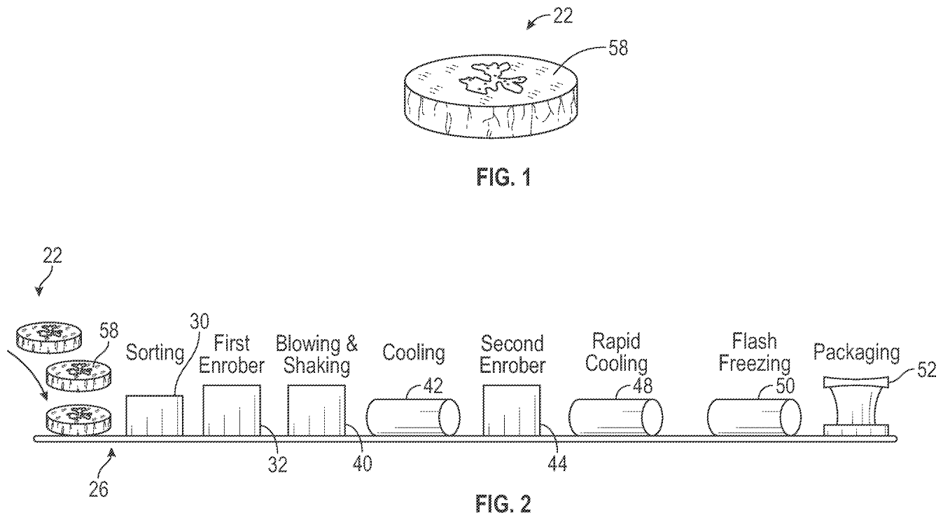

FIG. 1 shows an elevation view of a frozen banana 58 or other frozen food product 22. FIG. 2 shows a flow diagram comprising an overview of the steps of the present invention. Each step includes processing the frozen food product 22 along a conveying system 26 to create an enrobed frozen food product 28.

Those skilled in the art will appreciate that embodiments of the present invention embrace a variety of different configurations. For example, in some embodiments, a frozen food product 22 comprises a fruit. In some embodiment, the frozen food product 22 comprises a slice of banana, a raspberry, a blueberry, a strawberry, or a cherry, or any other suitable bite-size fruit or piece of fruit.

In some embodiments, a frozen food product 22 is received for processing, including whole pieces and partial pieces. Accordingly, in some embodiments, a first step in the process for preparing an enrobed frozen food product 28 includes sorting 30 the frozen food product 22 in such a way that discards pieces of the frozen food product 22 that are too small to process.

The frozen food product 22 is then transported along a conveying system 26. Each conveyor belt travels with increasing speed relative to the previous step to achieve thin layers of the peanut butter coating 61 and chocolate 62 and create separation between the frozen food products 22 and the enrobed frozen food products 28 throughout the process. One skilled in the art will appreciate that by conventional methods, each conveyor belt typically travels at a decreasing speed relative to the previous step positioning the confections closer together.

In some embodiments, a frozen food product 22 passes through a first enrober 32 to achieve a first thin layer of peanut butter coating 34, creating an enrobed frozen food product 28. Next, the enrobed frozen food product 28 is conveyed along a shaking belt 36 through blowers 38 to remove all peanut butter coating 61 in excess of a thin layer; this step is referred to as “blowing and shaking” 40. The enrobed frozen food product 28 is then conveyed along a cooling belt 42, at a temperature between about 1.7° C. and about 7.2° C., and through a second enrober 44 to achieve a second thin layer of chocolate 46. Next, the enrobed frozen food product 28 is conveyed through a rapid cooling tunnel 48 at a temperature below 1.7° C., followed by flash freezing 50 in an Individual Quick Frozen (“IQF”) unit at a temperature below −18° C. The IQF includes a perforated belt having high velocity, frozen air blowing up through the belt, and causing the enrobed frozen food product 28 to lift off the belt and separate from other enrobed frozen food products 28. The IQF is a standard machine in the industry; however, it is not typically used to process enrobed chocolate products. After flash freezing 50, the enrobed frozen food product 28 undergoes packaging 52. Packaging 52 takes place in a refrigerated environment, at a temperature below 4° C., as quickly as possible to prevent condensation from forming on the enrobed frozen food product 28.

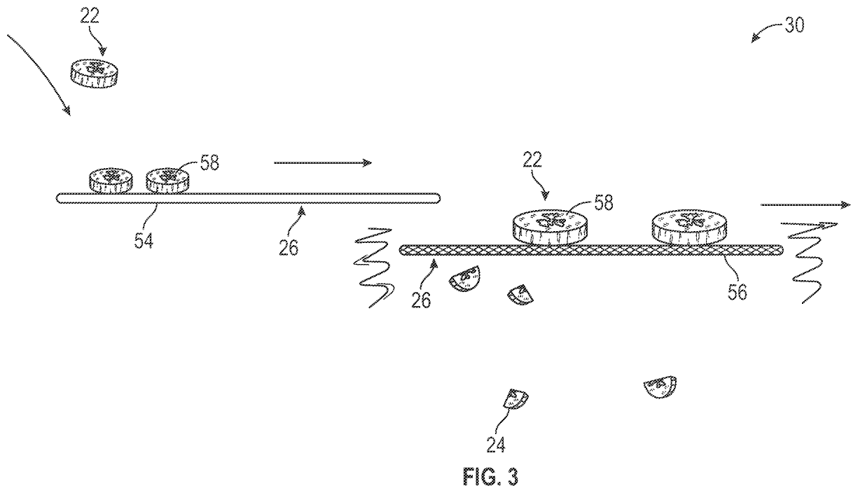

FIG. 3 shows a flow diagram of a sorting step 30 wherein whole pieces and partial pieces of a frozen food product 22 are received, and those pieces of the frozen food product 22 that are too small to be processed are discarded. The frozen food product 22 initially travels along an infeed belt 54 and onto a sorting belt 56. The infeed belt 54 and the sorting belt 56 form part of the conveying system 26. In some embodiments, the infeed belt 54 and the sorting belt 56 travel at a speed between about 0 meters per minute (“m/m”) and about 15 m/m, and more commonly at a speed between about 4 m/m and about 10 m/m. In some embodiments, the sorting belt 56 includes wire mesh with openings that are large enough to allow small pieces of the frozen food product 22 to pass through the openings. Furthermore, in some embodiments, the sorting belt 56 vibrates to encourage the small pieces of the frozen food product 22 to pass through the openings, and the small pieces of the frozen food product 22 that fall through the sorting belt 56 are removed from the process. The sorting step 30 prevents small pieces of the frozen food product 22 from falling through an enrobing belt at a subsequent step in the process and thereby adding undesirable moisture to the peanut butter or chocolate below. Furthermore, the sorting step is performed in such a way that minimizes friction and motion on the thin surface of the frozen food product 22 to reduce or eliminate damage.

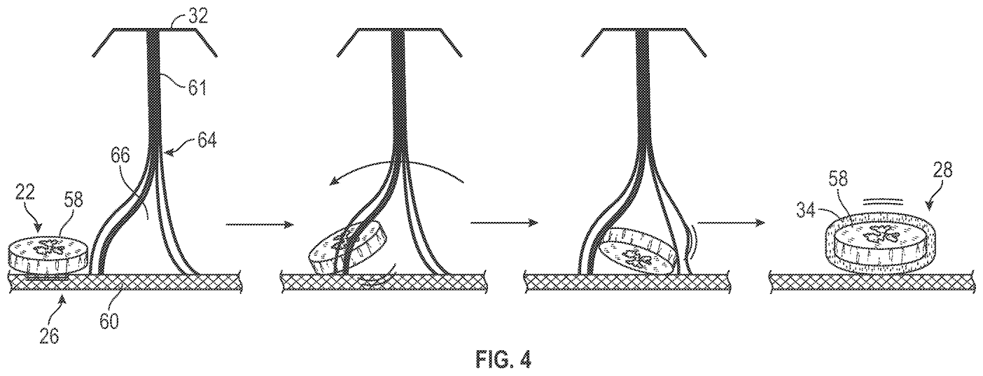

FIG. 4 shows a flow diagram of a first enrobing step. In some embodiments, a peanut butter coating 61 is used to enrobe a frozen food product 22 comprising peanuts ground into a fine paste, salt, and pure, high cocoa content white chocolate. Importantly, the unique composition contains no preservatives and no stabilizers. A person of ordinary skill in the art will appreciate the challenges associated with processing peanut butter that does not contain stabilizers. Adding pure, high cocoa content white chocolate to the peanut butter coating 61 aids in binding free peanut oil in the finely ground peanut paste, thereby reducing free oil migration. Free oil migration occurs when peanut oil separates from the finely ground peanut paste. The reduction in free oil migration produces multiple desirable characteristics. First, it results in desirable flow characteristics by allowing the peanut butter coating 61 to flow through the first enrober 32 in a consistent, thin curtain 64 in such a way that evenly and entirely coats the frozen food product 22. Second, adding pure, high cocoa content white chocolate to the peanut butter reduces the hygroscopic nature of the peanut butter. Without oil suspended in the peanut butter coating 61, it has a natural tendency to draw moisture out of the frozen food product 22. Reducing free oil migration lessens the hygroscopic tendency of the peanut butter coating 61 in such a way that it maintains a desirable moisture content, flavor, and mouthfeel in the enrobed frozen food product 28. Third and finally, adding pure, high cocoa content white chocolate to the peanut butter facilitates bonding between a first thin layer of peanut butter coating 34 and a second thin layer of chocolate 46.

In some embodiments, a peanut butter coating 61 is processed in a frozen state by enrobing a frozen food product 22 and immediately freezing the enrobed frozen food product 28. Processing the peanut butter coating 61 in a frozen state contributes to reducing free oil migration out of the peanut butter coating 61 in such a way that prevents blooming in a second thin layer of chocolate 46 and increases the shelf life of the enrobed frozen food product 28. Blooming occurs when the free oil migrates from the peanut butter coating 61 into the second thin layer of chocolate 46, causing the chocolate to develop an undesirable appearance. Additionally, processing the peanut butter coating 61 in a frozen state further aids in reducing hygroscopic properties and facilitates bonding between a first thin layer of peanut butter coating 34 and the second thin chocolate layer 46.

The enrobing step includes conveying a frozen food product 22 along a first enrobing belt 60 under a curtain 64 of a peanut butter coating 61 in such a way that completely envelopes the frozen food product 22 in the peanut butter coating 61. The first enrobing belt 60 forms part of a conveying system 26 and includes wire mesh to allow recovery of excess peanut butter coating 61 that drains through the first enrobing belt 60 as the frozen food product 22 is enveloped. Those skilled in the art will appreciate that in some embodiments, the first enrobing belt 60 travels at a speed between about 0 m/m and about 15 m/m, and more commonly at a speed between about 5 m/m and about 10 m/m, whereas typical enrobing belts in the industry travel at a speed of approximately 2 m/m. The first enrober 32 includes custom-made pumps equipped to process the peanut butter coating 71 and forces the peanut butter coating 61 to continuously flow downward over the first enrobing belt 60 creating the free-falling curtain 64 of the peanut butter coating.

In some embodiments, a plate resides directly below a first enrobing belt 60, referred to as a “bottomer.” As a curtain 64 of a peanut butter coating 61 cascades downward, it contacts the first enrobing belt 60 and the bottomer creating a wave 66. As a frozen food product 22 travels under the curtain 64 of the peanut butter coating 61, the wave 66 engulfs the frozen food product 22 and causes it to tip over, thereby completely coating the frozen food product 22. Because of the good flow characteristics of the peanut butter coating 61, the peanut butter coating 61 captures the entire surface of the frozen food product 22 filling any irregularities. The peanut butter coating 61 begins to harden immediately upon contacting the frozen food product 22. As the frozen food product 22 exits the first enrober 32, it emerges as an enrobed frozen food product 28 coated in a first thin layer of peanut butter coating 34.

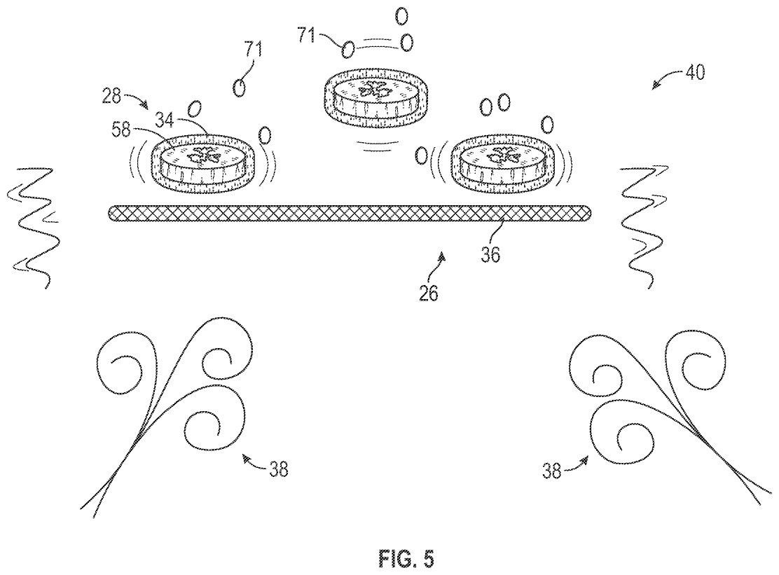

FIG. 5 shows an elevation view of a blowing and shaking step 40. In some embodiments, an enrobed frozen food product 28 is conveyed along an aggressively shaking belt 36 and through blowers 38 creating high-velocity air blowing up through the belt to remove all peanut butter coating 61 in excess of a thin layer. In some embodiments, the aggressive motion of the shaking belt 36, combined with the forced air blowing up through the belt from the blowers 38, propels the enrobed frozen food product 28 into irregular motion. This irregular motion further aids in removing any peanut butter coating 61 from the enrobed frozen food product 28 in excess of a first thin layer of peanut butter coating 34. The shaking belt 36 includes wire mesh with openings to allow excess peanut butter coating 71 to fall through the openings. The shaking belt 36 forms part of a conveying system 26. In some embodiments, the thickness of the first thin layer of peanut butter coating 34 is between about 0 millimeters (“mm”) and about 5 mm, and more commonly between about 1 mm and about 2 mm. In some embodiments, the excess peanut butter coating 71 that falls through the openings in the shaking belt 36 is removed from the process. In some embodiments, the excess peanut butter coating 71 that falls through the openings in the shaking belt 36 is recycled into the process.

In some embodiments, the enrobed frozen food product 28 is then conveyed along a cooling belt 42, at a temperature between about 0° C. and about 10° C., more commonly between about 1.7 C and about 7.2° C., thereby hardening the peanut butter coating 61 on the bottom of the enrobed frozen food product 28. The cooling belt 42 forms part of a conveying system 26. In some embodiments, the cooling belt 42 travels at a speed between about 0 m/m and about 15 m/m, and more commonly at a speed between about 6 m/m and about 10 m/m.

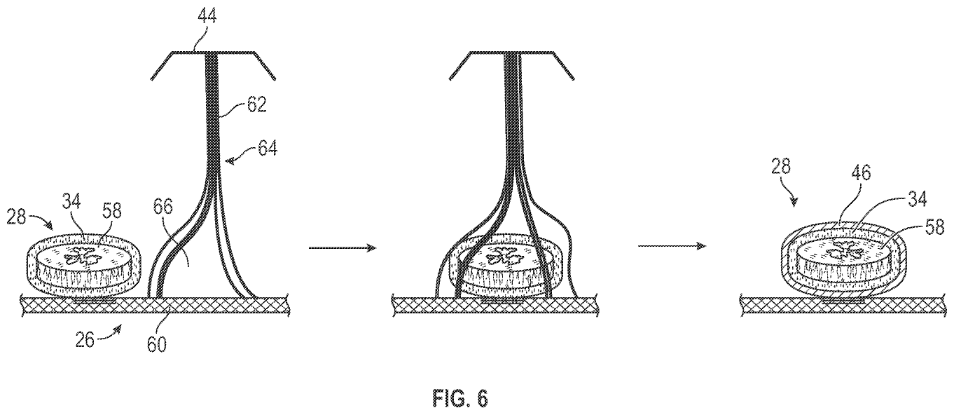

FIG. 6 shows a flow diagram of a second enrobing step 44. In some embodiments, the enrobing chocolate comprises a pure cocoa butter chocolate with additional cocoa butter, resulting in a pure, high cocoa content chocolate 62. Increasing the amount of cocoa butter in chocolate decreases the melting point of the chocolate to achieve a low viscosity chocolate with good flow characteristics. Because of the low melting point of the pure, high cocoa content chocolate 62, the chocolate begins to melt immediately when consumed, creating a sensation referred to in the industry as “meltaway.” Using the pure, high cocoa content chocolate 62 obviates the need for incorporating other agents into the chocolate, such as coconut oil and butter. In some embodiments, the pure, high cocoa content chocolate 62 is untempered and processed at a temperature between about 37.8° C. and about 43.3° C. Using untempered chocolate allows rapid cooling and freezing of an enrobed frozen food product 28 as soon as the chocolate is applied.

In some embodiments, a second enrobing step 44 includes conveying an enrobed frozen food product 28 along a second enrobing belt 72 under a curtain 64 of a pure, high cocoa content chocolate 62 in such a way that it coats the enrobed frozen food product 28 in a second thin layer of chocolate 46. The second enrobing belt 72 forms part of a conveying system 26 and includes wire mesh to allow recovery of excess chocolate that drains through the second enrobing belt. 72 as the enrobed frozen food product 28 is enveloped. Those skilled in the art will appreciate that in some embodiments, the second enrobing belt 72 travels at a speed between about 0 m/m and about 15 m/m, and more commonly at a speed between about 6 m/m and about 10 m/m. The second enrober 44 includes custom-made pumps designed to process low viscosity chocolate and forces the pure, high cocoa content chocolate 62 to continuously flow downward over the second enrobing belt 72 creating the free-falling curtain 64. In some embodiments, a plate resides directly below a second enrobing belt 72, referred to as a “bottomer.” A wave 66 is created as the curtain 64 of pure, high cocoa content chocolate 62 cascades downward and contacts the second enrobing belt 72 and the bottomer. The wave 66 engulfs the enrobed frozen food product 28 as it travels under the curtain 64 of pure, high cocoa content chocolate 62. In some embodiments, the enrobed frozen food product 28 does not flip over during the second enrobing step, thereby creating feet along a bottom surface of the second thin layer of chocolate 46 where the enrobed frozen food product 28 contacts the second enrobing belt 72.

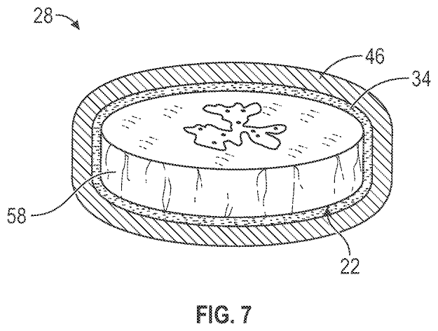

FIG. 7 shows a cross-sectional view of an enrobed frozen banana 58 or other enrobed frozen food product 28 as it exits a second enrober 44, coated in a first thin layer of peanut butter coating 34, and a second thin layer of chocolate 46. In some embodiments, the final composition of the enrobed frozen food product 28 comprises about 45% frozen banana 58, about 30% peanut butter coating 61, and about 25% pure, high cocoa content chocolate 62. In some embodiments, the thickness of the second thin layer of chocolate 46 is between about 0 mm and about 5 mm, and more commonly between about 1 mm and about 2 mm. In some embodiments, the second thin layer of chocolate 46 includes white chocolate, milk chocolate, or dark chocolate.

In some embodiments, an enrobed frozen food product 28 is conveyed through a rapid cooling tunnel 48 immediately after a second enrober 44 and cooled to a temperature below 1.7° C. In some embodiments, the rapid cooling tunnel 48 includes a second cooling belt that forms part of a conveying system 26. In some embodiments, the second cooling belt travels at a speed between about 0 m/m and about 15 m/m, and more commonly at a speed between about 6 m/m and about 10 m/m.

In some embodiments, an enrobed frozen food product 28 then undergoes flash freezing 50 in an IQF unit to a temperature below −18° C. The IQF includes a perforated belt having high velocity, frozen air blowing up through the belt, and causing the enrobed frozen food product 28 to lift off the belt and separate from other enrobed frozen food products 28. The IQF is a standard machine in the industry; however, it is not typically used to process enrobed chocolate products. After flash freezing 50, the enrobed frozen food product 28 undergoes packaging 52. Packaging 52 takes place in a refrigerated environment, at a temperature below 4° C., as quickly as possible to prevent condensation from forming on the enrobed frozen food product 28.

The present invention relates to improved methods for completely enrobing a frozen food product in thin layers of peanut butter and chocolate. The invention also relates to a unique peanut butter coating composition and processing the peanut butter coating in a frozen state, thereby reducing free oil migration. The invention also relates to the ability to envelop the frozen food product in a thin layer of untempered, pure cocoa butter chocolate to prevent the chocolate from becoming cloudy or frangible, and then rapidly chill and freeze the chocolate covered frozen food product.

A person of ordinary skill in the art will appreciate that in some embodiments, a peanut butter coating used to enrobe the frozen food product does not include any preservatives or stabilizers. Instead, the peanut butter coating comprises peanuts ground into a fine paste, salt, and pure, high cocoa content white chocolate. Adding pure, high cocoa content white chocolate to the peanut butter aids in binding free peanut oil in the finely ground peanut paste, thereby reducing free oil migration. Additionally, the present invention relates to processing the peanut butter coating at frozen temperatures in such a way that further reduces free oil migration.

A person of ordinary skill in the art will also appreciate that in some embodiments, the chocolate used to enrobe the frozen food product comprising a pure cocoa butter chocolate with additional cocoa butter to achieve a low viscosity, low melting point chocolate without including other agents such as coconut oil or butter. One skilled in the art will equally appreciate the ingenuity and uniqueness of enrobing frozen food products in an untempered chocolate. Because the chocolate is untempered, it can be cooled and frozen immediately after application onto the frozen food product. In this way, the color and texture of the chocolate is preserved, thereby preventing discoloration or brittleness of the chocolate coating. In some embodiments, the frozen food product is first enrobed in a thin layer of peanut butter coating followed by a thin layer of white, dark, or milk chocolate.

In some embodiments, as the frozen food product is enrobed in chocolate, it travels along a conveying system at least four times as fast as conventional methods. For example, the first enrobing belt in the present invention travels at a speed between about 5 m/m and about 10 m/m. In contrast, enrobing belts in the industry typically travel at a speed of 2 m/m. One skilled in the relevant art will recognize that applying peanut butter or chocolate onto a frozen confection by conventional methods results in thick, frozen layers that are difficult for a consumer to bite into. However, the enrobing methods of the present invention, wherein the frozen food product is quickly enrobed in a peanut butter coating followed by blowing and shaking to remove any peanut butter coating in excess of a thin layer, creates a frozen food product enrobed in thin layers of peanut butter coating and chocolate, between about 0 mm and about 5 mm, and more commonly between about 1 mm and about 2 mm, that is pleasing to bite into.

The present invention may be embodied in other specific forms without departing from its spirit or essential characteristics. The described embodiments are to be considered in all respects, only as illustrative and not restrictive. The scope of the invention is, therefore, indicated by the appended claims rather than by the foregoing description. All changes which come within the meaning and range of equivalency of the claims are to be embraced within their scope.

1-9. (canceled)

10. A process of applying a peanut butter coating and an untempered chocolate onto a frozen food product that forms thin layers of the peanut butter coating and the chocolate, reduces free oil migration out of the peanut butter coating, and prevents the chocolate from becoming cloudy and frangible, comprising:
a frozen food product;
a peanut butter coating comprising finely ground peanuts and salt;
a low viscosity, untempered, chocolate containing pure cocoa butter;
applying a first layer of the peanut butter coating by conveying the frozen food product along a first enrobing belt under an enrobing curtain of the peanut butter coating to envelop the frozen food product in the peanut butter coating;
conveying an enrobed frozen food product along a vibrating perforated belt having pressurized air passing up through the belt to remove all peanut butter coating in excess of a thin layer;
cooling the enrobed frozen food product to a temperature between about 1.7° C. and about 7.2° C.;
applying a second layer of a chocolate, comprising the low viscosity, untempered, chocolate containing pure cocoa butter, by conveying the enrobed frozen food product along a second enrobing belt under a second enrobing curtain of the chocolate to envelop the enrobed frozen food product in the chocolate;
flash cooling the enrobed frozen food product to a temperature below 1.7° C.;
freezing the enrobed frozen food product to a temperature below −18° C.; and
rapidly packaging the enrobed frozen food product at a temperature below 4° C., thereby creating a packaged product and freezing the packaged product in such a way that prevents condensation from forming on the enrobed frozen food product.

11. The frozen food product as recited in claim 10, wherein the frozen food product is a fruit.

12. The frozen food product as recited in claim 10, wherein the frozen food product is a slice of banana.

13. The peanut butter coating recited in claim 10, wherein the peanut butter coating comprises pure, high cocoa content white chocolate to reduce free oil migration out of the peanut butter coating.

14. The process of claim 10, wherein the second layer contains a white chocolate.

15. The process of claim 10, wherein the second layer contains a dark chocolate.

16. The process of claim 10, wherein the second layer contains a milk chocolate.

17. A process of applying a peanut butter coating and an untempered chocolate onto a frozen food product that forms layers of the peanut butter coating and the chocolate between about 1 mm and about 2 mm thick, reduces free oil migration out of the peanut butter coating, and prevents the chocolate from becoming cloudy and frangible, comprising:
a frozen food product;
a peanut butter coating comprising finely ground peanuts, 1% added salt, and pure, high cocoa content white chocolate;
a low viscosity, untempered, chocolate containing pure cocoa butter;
applying a first layer of the peanut butter coating by conveying the frozen food product along a first enrobing belt, traveling at a speed between about 5 m/m and about 10 m/m, under a first enrobing curtain of the peanut butter coating to envelop the frozen food product in the peanut butter coating;
conveying an enrobed frozen food product along a conveyor belt, having pressurized air passing up through the conveyor belt to remove all peanut butter coating in excess of a layer between about 1 mm and about 2 mm thick;
cooling the enrobed frozen food product to a temperature between about 1.7° C. and about 7.2° C., by conveying the enrobed frozen food product along a cooling belt, traveling at a speed between about 6 m/m and about 10 m/m, to harden the peanut butter coating along a bottom surface of the enrobed frozen food product;
applying a second layer of chocolate, comprising low viscosity untempered pure cocoa butter chocolate, between about 1 mm and about 2 mm thick, at a temperature between 37.8° C. and 43.3° C., by conveying the enrobed frozen food product along a second enrobing belt, traveling at a speed between about 6 m/m and about 10 m/m, under a second enrobing curtain of the chocolate to envelop the enrobed frozen food product in chocolate;
flash cooling the enrobed frozen food product to a temperature below 1.7° C., by conveying the enrobed frozen food product along a second cooling belt, traveling at a speed between about 6 m/m and about 10 m/m;
freezing the enrobed frozen food product to a temperature below −18° C.; and
rapidly packaging the enrobed frozen food product at a temperature below 4° C., thereby creating a packaged product and freezing the packaged product in such a way that prevents condensation from forming on the enrobed frozen food product.

18. The frozen food product as recited in claim 17, wherein the frozen food product is a fruit.

19. The frozen food product as recited in claim 17, wherein the frozen food product is a slice of banana.

20. The process of claim 17, wherein the second layer contains a white chocolate, a milk chocolate, or a dark chocolate.

21. A process of applying a peanut butter coating and an untempered chocolate onto a frozen food product that forms thin layers of the peanut butter coating and the chocolate, reduces free oil migration out of the peanut butter coating, and prevents the chocolate from becoming cloudy and frangible, comprising:
a frozen food product;
a peanut butter coating;
a low viscosity, untempered, chocolate containing pure cocoa butter;
applying a first layer of the peanut butter coating by conveying the frozen food product along a belt under an enrobing curtain of the peanut butter coating to envelop the frozen food product in the peanut butter coating;
conveying an enrobed frozen food product along a vibrating perforated belt having pressurized air passing up through the belt to remove all peanut butter in excess of a thin layer;
flash cooling the enrobed frozen food product to a temperature below 1.7° C.; and
freezing the enrobed frozen food product to a temperature below −18° C.

22. The frozen food product as recited in claim 21, wherein the frozen food product is a fruit.

23. The frozen food product as recited in claim 21, wherein the frozen food product is a slice of banana.

24. The peanut butter coating of claim 21, wherein the peanut butter coating comprises finely ground peanuts, salt, and pure, high cocoa content white chocolate to reduce free oil migration out of the peanut butter coating.

25. The process of claim 21, wherein the step of enrobing comprises enveloping the frozen food product in a first layer of peanut butter coating and then enrobing the frozen food product in a second layer of a chocolate, comprising the low viscosity, untempered, chocolate containing pure cocoa butter.

26. The process of claim 25, wherein the second layer contains a white chocolate.

27. The process of claim 25, wherein the second layer contains a milk chocolate.

28. The process of claim 25, wherein the second layer contains a dark chocolate.

29. The process of claim 21, further comprising:
rapidly packaging the enrobed frozen food product at a temperature below 4° C., thereby creating a packaged product and freezing the packaged product in such a way that prevents condensation from forming on the enrobed frozen food product.
